(19) United States
(12) Patent Application Publication
(10) Pub. No.: US 2009/0043601 A1
(43) Pub. Date: Feb. 12, 2009

(54) Repair Procedure Development System

(75) Inventors: Joseph M. Schuh, Rockledge, FL (US); Mary Jo Al-Shihabi, Merritt Island, FL (US); Martin A. Belson, Chuluota, FL (US); Derek A. Hardin, Orlando, FL (US); Nadean L. King, Cocoa, FL (US); Louis W. Locklear, Oviedo, FL (US); Brent H. Mitchell, Melbourne, FL (US); Elkin F. Norena, Orlando, FL (US)

Correspondence Address: NASA JOHN F. KENNEDY SPACE CENTER, MAIL CODE: CC-A/OFFICE OF CHIEF COUNSEL, ATTN: PATENT COUNSEL, KENNEDY SPACE CENTER, FL, 32899, US

(73) Assignees: United States of America as Represented by the Administrator of the National Aeronautics and; Space Administration, Washington, DC (US)

(21) Appl. No.: 12/101,424

(22) Filed: Apr. 11, 2008

Related U.S. Application Data
(60) Provisional application No. 60/911,319, filed on Apr. 12, 2007.

(51) Int. Cl. G06Q 99/00

(52) U.S. Cl. 705/1

(57) ABSTRACT

A repair procedure development system is disclosed that may allow for an organized, automated decision making approach to repairs. Some embodiments use four categories and sub-categories of component, subcomponent, discrepancy, and repair, although other categories and numbers of categories may be used. The repair procedure development system may use a decision analysis tree to cycle through all possible permutations in the categories, and may therefore generate all possible discrepancies and repairs for particular hardware elements. In addition, the repair procedure development system may use a repair matrix to define the steps and sequences that are needed to perform any repair defined in the decision tree, with the option to select specific steps from multivariable steps. The repair procedure development system may capture knowledge data from one or more technical groups and may help merge specification requirements with repair procedures. The repair procedure development system may be transferable to other engineering groups. The repair procedure development system may allow an engineer to spend more time on the floor working issues, to interact more among technical disciplines, and to play a more proactive role in processing, while increasing technical accuracy and safety by reducing errors and communication disconnects.

### CROSS-REFERENCE TO RELATED APPLICATIONS

The application claims the benefit, under 35 U.S.C. §119(e), of U.S. Provisional Application Ser. No. 60/911,319, filed Apr. 12, 2007, the contents of which are incorporated herein by reference.

### ORIGIN OF THE INVENTION

The invention described herein was made in the performance of work under a NASA contract and by an employee of the United States Government and is subject to the provisions of Section 305 of the National Aeronautics and Space Act of 1958, as amended, Public Law 85-568 (72 Stat. 435, 42 U.S.C. §2457), and may be manufactured and used by or for the Government for governmental purposes without the payment of any royalties thereon or therefore.

### BACKGROUND OF THE INVENTION

1. Field of the Invention

The present invention is directed to preparation of repair procedures for mechanical or electric hardware and storage of tacit knowledge.

2. Description of the Related Art

A complicated mechanical and/or electrical system, such as a spacecraft, requires a system for developing repair procedures.

Typically, repair procedures are created manually by individuals, who manually compile information from a variety of sources. There are a number of shortcomings to creating repair procedures in this manner, some of which are described below.

Typically, there is no standardized and/or uniform process for evaluating discrepancies, or for deciding on potential repair sequences.

Typically, tacit knowledge, or specific technical information relating to the system under repair, is contained only by members of a technical group, and is often not passed on to new employees or management.

Typically, no document or database exists that connects specification requirements with acceptable repairs, with de-configuring and reconfiguring hardware, and overall tacit knowledge required for a complete procedure.

Typically, efficient repair clusters are difficult to accomplish, requiring that teardown and/or power-down processes be repeated for multiple repairs.

Typically, repair work document disposition is overly time-consuming because it involves many manual processes.

Typically, the engineer and/or operator considers many variables at the same time, making mistakes more abundant for complicated systems.

Typically, there are frequent typographical and cut-and-paste errors in the resulting repair process.

A great deal may be at stake in the operation of these systems, such as human lives and great expense, so it is desirable to develop repair procedures in a manner that reduces the risk of errors in the procedures; increases the technical accuracy of the procedures; reduces the effort, time, and expense of developing the procedures; and reduces the non-uniformities from procedure to procedure.

### BRIEF SUMMARY OF THE INVENTION

An embodiment is a computer system for producing a repair procedure, the computer system being configured for: presenting a first group of components for selection; receiving a selected component from the first group of components; presenting a second group of subcomponents for selection in response to the selected component; receiving a selected subcomponent from the second group of subcomponents; presenting a third group of discrepancies for selection in response to the selected subcomponent; receiving a selected discrepancy from the third group of discrepancies; presenting a fourth group of repairs for selection in response to the selected discrepancy; and receiving a selected repair from the fourth group of repairs.

A further embodiment is a method for preparing a repair procedure, comprising: selecting a discrepant item; associating a unique identification datum with the discrepant item; presenting a set of repair tasks associated with the discrepant item; receiving a selected subset of the set of repair tasks; associating the selected subset of repair tasks with the unique identification datum; identifying a plurality of step/boiler names required to perform the selected subset of repair tasks; and providing the plurality of step/boiler names to an authoring application.

A further embodiment is a computer system for producing a repair procedure, the computer system being configured for: presenting a first group of components for selection; receiving a first selected component from the first group of components; presenting a second group of subcomponents for selection, the second group of subcomponents being determined in part by the first selected component; receiving a second selected subcomponent from the second group of subcomponents; presenting a third group of discrepancies for selection, the third group of discrepancies being determined in part by the second selected subcomponent; receiving a third selected discrepancy from the third group of discrepancies; presenting a fourth group of repairs for selection, the fourth group of repairs being determined in part by the third selected discrepancy; and receiving a fourth selected repair from the fourth group of repairs. The first group of components, the second group of subcomponents, the third group of discrepancies and the fourth group of repairs are included in a predetermined repair decision analysis tree.

A further embodiment is a computer system for producing a repair procedure, the computer system being configured for: presenting a first group of elements in a first category for selection; receiving a first selected element from the first group of elements; presenting a second group of elements in a second category for selection in response to the first selected element; receiving a second selected element from the second group of elements; and providing a repair procedure determined in part by the second selected element. The first and second groups of elements are included in a predetermined repair decision analysis tree.

### BRIEF DESCRIPTION OF THE DRAWINGS

FIG. 1 is a flowchart of an exemplary repair procedure development system.

FIG. 2 is a flow chart of an exemplary decision analysis tree.

FIG. 3 is a portion of an exemplary repair matrix.

### DETAILED DESCRIPTION OF THE INVENTION

A complicated mechanical and/or electrical system, such as a spacecraft, requires a system for developing repair procedures.

The present application discloses a repair procedure development system that may reduce or eliminate authoring data errors, may improve the timely delivery and technical accuracy of the repair procedures, and may create a knowledge base of engineering repair processes.

In some embodiments, hardware of the complicated system may be systematically organized using four categories: component, subcomponent, discrepancy, and repair. Based on these four categories and the hardware elements contained therein, there is only a finite number of permutations that can occur, with a corresponding finite number of discrepancies and repairs.

Alternatively, more or fewer than four categories may be used, including one category, two categories, three categories, four categories, five categories, and so forth. In general, the number of categories may be any suitable number for the particular application.

For instance, a particularly simple assembly, such as a bolt, may require only one category, which may be “component.” For these simple assemblies, it may be sufficient to call out just the component; if a bolt appears defective, then the repair procedure may be to simply replace the bolt, without requiring input from the user as to what seems wrong with the bolt.

Alternatively, a particularly complicated assembly, such as a jet engine, may require many more categories than the sample five listed above. In some instances, these complex assemblies may require ten or more categories, and may require a great deal of input from the user to determine what needs fixing and how it should be fixed.

The categories may also include various subcategories. For instance, one may organize hardware simply as: component, subcomponent, discrepancy, and repair. Alternatively, one may organize any or all pieces of hardware in a more complicated structure, such as: component, component, subcomponent, subcomponent, subcomponent, discrepancy, discrepancy, discrepancy, discrepancy, repair, and repair. In this manner, any or all of the four categories may be repeated as often as necessary as subcategories. The subcategories may be the same for all pieces of hardware in the system, or may alternatively vary from part to part. Even with these optional subcategories, there are only a finite number of permutations that can occur, with a corresponding finite number of discrepancies and repairs.

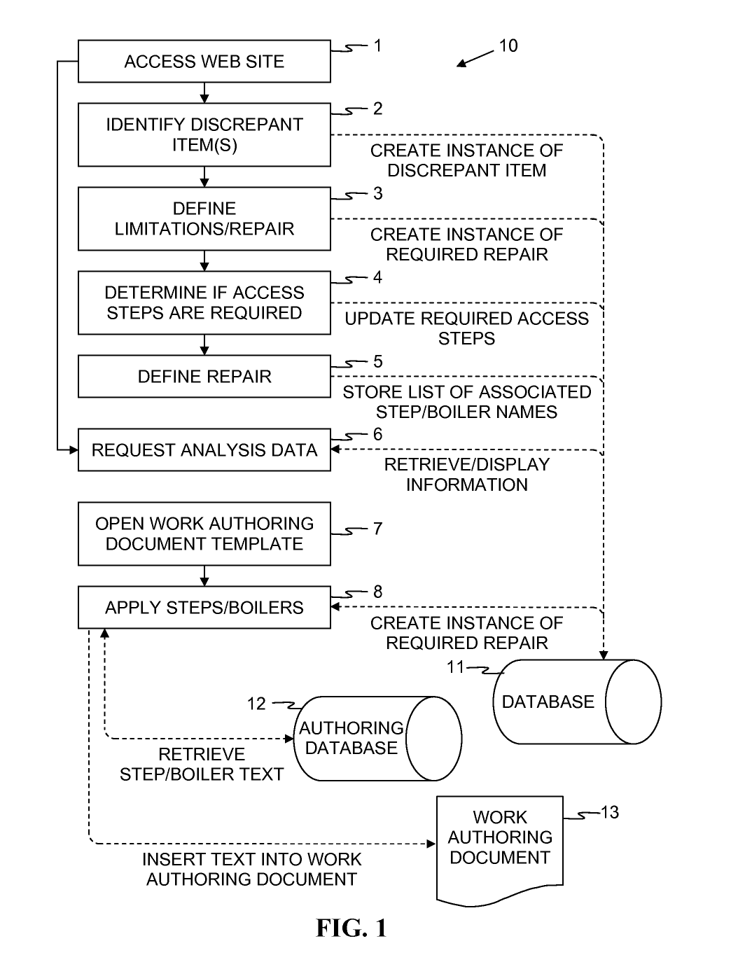

The repair procedure development system may use a decision analysis tree to cycle through all possible permutations in the four (or more or fewer than four) categories, and may therefore generate all possible discrepancies and repairs for particular hardware elements. In addition, the repair procedure development system may use a repair matrix to define the steps and sequences that are needed to perform any repair defined in the decision tree, with the option to select specific steps from a list of multivariable steps. The repair procedure development system is discussed in further detail using the flowchart in FIG. 1.

FIG. 1 is a flowchart of an exemplary repair procedure development system 10. In element 1, an engineer may log on to a particular web page or web site to begin the process of identifying and refining a problem description through various levels of a predefined decision tree. It is understood that the web page or web site may be stored locally on a server, or may be accessed through the internet or other networking devices.

In element 2, the engineer navigates through a step process to precisely identify a discrepant condition or item. The step process may be referred to as a decision tree, and may involve choosing responses from a series of multiple choice questions, where each choice determines, in part, the future questions. The choices may be made using only text-based prompts and responses, or may optionally include pictures in the prompts and/or responses. The decision tree is predetermined, and is developed by engineering or qualified personnel that identifies the various possible components, subcomponents, discrepancies, and repairs. Once the engineer has navigated through the decision tree, the system creates an instance of the discrepant condition or discrepancy. The discrepant condition may be passed to a repair procedure database 11, and may optionally be based on a unique identification number that may be generated by the database 11 and/or the website and/or the server on which the website runs.

In element 3, the system presents to the engineer a set of all possible repair tasks associated with the discrepancy. Based on location and flow status, the engineer may identify from the list of all possible repair tasks the tasks required to perform the repair, as well as the discrepancy within the unique identification number.

Optionally, the system may also look to an outside database to automatically determine some steps/boilers as data. The system may optionally bring this data into the program for storage and display.

In element 4, the engineer determines if access steps are required to perform the repair. For instance, a task may require that items such as panels be removed in order to access the problem area. The engineer may identify the tasks associated with the installation or removal of any related hardware.

In element 5, the engineer has completed all the required analysis. The tasks needed to repair the discrepancy are captured in the system, and a listing of the needed step/boiler names is made available to the database 11.

In element 6, a user may wish to view information stored in the database 11, and may log in to the website in element 1 with a login ID that allows them read and/or write access to the database 11. Access may be determined by a system administrator. Element 6 is useful as an administrative tool, and may not be critical to identifying discrepancies and defining repairs.

In elements 7 and 8, an engineer may wish to modify a work authoring document template, which is a task that lies outside the construct of elements 1-5. In element 7, the engineer or other qualified personnel may open the work authoring document template. Element 7 identifies that a list of step/boiler names are in the database 11 and require that the appropriate text be entered into the work authoring document 13. The engineer identifies the related information by using the discrepancy number and the related item number.

In element 8, once the user identifies the discrepancy number and related item number, a work authoring document macro may access the database 11 to retrieve to the step/boiler names from the authoring database 12 and use them to pull the text and/or graphics and/or data associated with each name and insert it into the work authoring environment, or the work authoring document 13.

There are many features and advantages of the repair procedure development system 10, which are listed below.

In some embodiments, the repair procedure development system 10 may result in significant time savings. For instance, for Orbiter Electrical Engineering, there may be an estimated 50% overall time savings to process a repair document, with a 90% time savings to produce the document.

In some embodiments, the repair procedure development system 10 may reduce human error. This may result in the reduction or elimination of typographical and/or cut-and-paste errors in the resulting repair procedures.

In some embodiments, the repair procedure development system 10 may have a consistent disposition. For instance, the development system 10 may include a controlled set of repair sequence and steps. These steps may be used as needed in various repair documents.

In some embodiments, the concept, layout, function, methods, and/or benefits of the repair procedure development system 10 may be transferable to any entity that includes equipment that is repairable, and may be transferable to next generation vehicle applications.

In some embodiments, the repair procedure development system 10 may improve overall operational awareness by allowing system experts to spend more time on the floor working hardware issues, interacting more between engineering disciplines and playing a more proactive role.

In general, the procedures within the repair procedure development system 10 may help ensure that proper personal and hardware safety steps are followed, thereby preventing injuries and hardware damage. In addition, the repair procedure development system 10 may help reduce the amount of manual, mundane processes required to generate a repair sequence, and may help the engineer to more efficiently orchestrate the repair sequence.

In some embodiments, the repair procedure development system 10 may be a front end online program, whose output may be used by any repair procedure authoring environment.

In some embodiments, the repair procedure development system 10 may allow for specific access steps for a particular piece of equipment within a vehicle under repair.

In some embodiments, the repair procedure development system 10 may allow for a selection to be made from a multivariable step procedure, based on one or more particular needs of the author of the procedure.

In some embodiments, the repair procedure development system 10 may contain logic to automatically select an individual multi-variable step based on data from an external database.

In some embodiments, the repair procedure development system 10 may interface with other databases, such as a Shuttle Connector Analysis Network database, or a Parts Material Equipment and Tools database.

In some embodiments, the repair procedure development system 10 may prompt a user for information, and then use information from the user to populate automatically a document with information from an external database, such as a Shuttle Connector Analysis Network database, or a Parts Material Equipment and Tools database.

In some embodiments, the repair procedure development system 10 may contain a list of steps needed to complete a repair. The order in these steps may optionally be changed manually by a user, or automatically by the development system itself.

In some embodiments, the repair procedure development system 10 may provide an output in the format of an Oracle table, which may then in turn be used by any software that can receive an Oracle table as input.

In some embodiments, the repair procedure development system 10 may optionally capture data from different databases, with the ability to save and/or export data.

In some embodiments, the repair procedure development system 10 may interface with any future programs, database, and/or change of business plan, while retaining the same decision analysis functionality. For instance, the authoring environment may change or evolve over time, but the link between specification requirements and repair methods may be retained and may be used by whichever version of the authoring environment is used at the time.

In some embodiments, the repair procedure development system 10 may help reduce life-cycle costs for any organization where technical knowledge is used to operate, maintain or repair mechanical or electrical hardware.

In some embodiments, the repair procedure development system 10 may allow the user a single interface point that helps merge configuration, safety, technical, corporate knowledge, sequential, decision analysis, and hardware requirements together within the development system 10. This is in contrast with known development systems, in which these elements are manually composed from multiple sources and databases to create the repair procedure.

In some embodiments, the repair procedure development system 10 may be an interactive decision analysis and refinement software system designed to utilize evaluation criteria for discrepant conditions and to automatically populate a document with predefined steps necessary to repair a discrepancy in a safe, accurate and efficient manner.

In some embodiments, the repair procedure development system 10 may be designed to capture the thought process involved in decision analysis and provide that information in a user friendly automated decision making system.

In general, the repair procedure development system 10 fits into the current maintenance process as follows. First, a discrepancy is found. Next, an engineer uses the decision analysis of the repair procedure development system 10. Then, the engineer imports steps and/or one or more data sequences from the repair procedure development system 10 into a repair document. Finally, the repair document is brought to the floor to work.

The repair procedure development system 10 may allow an engineer to step through a decision tree and may automatically assemble the repair procedure using the engineer's responses, as well as input from one or more databases regarding any or all of hardware requirements, configuration requirements, program requirements, quality requirements, operating procedures, workmanship standards, corporate knowledge, applicable equipment, tools and certifications, safety requirements, and parts and materials.

In summary, the repair procedure development system 10 may allow for an organized, automated decision making approach to repairs, using the categories and sub-categories of component, subcomponent, discrepancy, and repair. The repair procedure development system 10 may capture knowledge data from one or more technical groups and may help merge specification requirements with repair procedures. The repair procedure development system 10 may be transferable to other engineering groups. The repair procedure development system 10 may allow an engineer to spend more time on the floor working issues, to interact more among technical disciplines and to play a more proactive role in processing, while increasing technical accuracy and safety by reducing errors and communication disconnects.

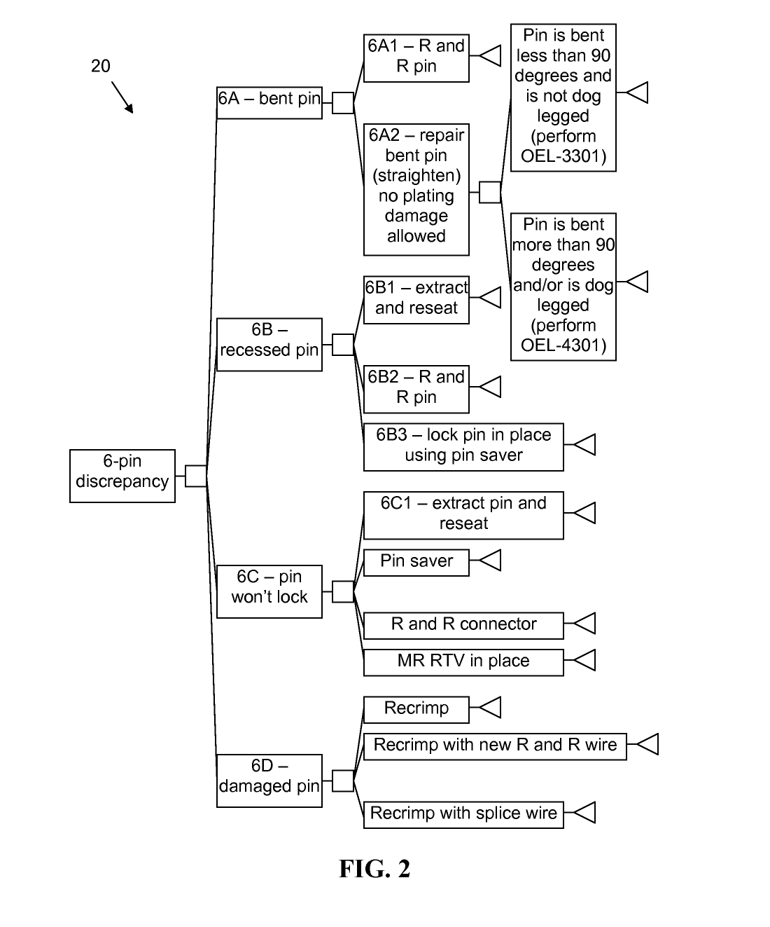

FIG. 2 is a flow chart of an exemplary decision analysis tree 20 or decision tree 20. Decisions are made at the unlabelled squares, and specific repairs are made at the unlabelled triangles. In practice, the flow chart cells shown in FIG. 2 may be part of a much larger decision analysis tree that defines all the permutations among components, subcomponents, discrepancies, and repairs. The organization of this decision analysis tree creates the link between specification requirements of the hardware and specific procedures required to repair discrepancies.

For instance, if there is a 6-pin discrepancy, the repair procedure development system 10 may present the user with four choices: bent pin, recessed pin, pin won't lock, and damaged pin. The user selects one of the four choices, which moves the user to the next level of the decision tree. Each branch in the decision tree terminates in a specific repair, so the user reaches a specific repair by answering a sufficient number of questions to put the user at the end of one of the branches.

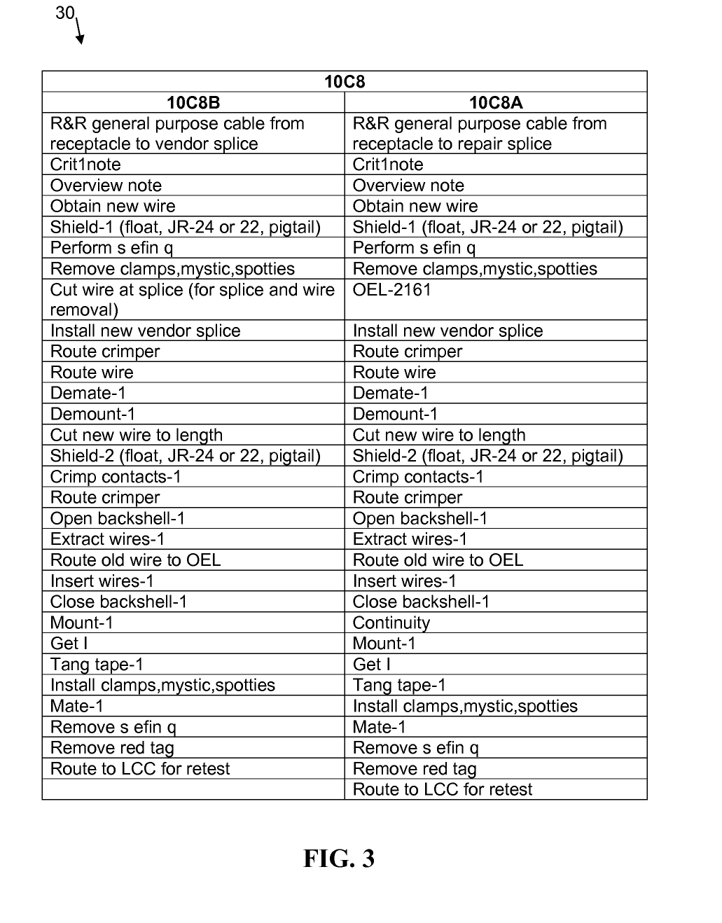

FIG. 3 is a portion of an exemplary repair matrix 30 that defines what the sequence and steps are for all repairs defined in the decision tree 20. The repair matrix 30 may also allow for the selection of specific steps from multivariable steps. Note that there are a finite number of steps that are needed to repair a component.

The following paragraph describes a sample use of the repair procedure development system 10 for repairing a vehicle. This is merely an example, and should not be construed as limiting in any way.

An engineer logs onto the web page and begins the process of identifying and refining a problem description through various levels of a predefined decision tree. Based on the results of this process, the development system 10 identifies a set of predefined steps that may resolve the problem. Some of the steps may be identified as optional and may only be used based on the location and status of the vehicle under repair. The output from this analysis may be sent to a work authoring system in the form of a predefined sequence of steps containing actions, tools, parts, materials, certifications, and/or specific requirements.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. A computer system for producing a repair procedure, the computer system being configured for:
presenting a first group of components for selection;
receiving a selected component from the first group of components;
presenting a second group of subcomponents for selection in response to the selected component;
receiving a selected subcomponent from the second group of subcomponents;
presenting a third group of discrepancies for selection in response to the selected sub component;
receiving a selected discrepancy from the third group of discrepancies;
presenting a fourth group of repairs for selection in response to the selected discrepancy; and
receiving a selected repair from the fourth group of repairs.

2. The computer system of claim 1, wherein the first group of components, the second group of subcomponents, the third group of discrepancies, and the fourth group of repairs are included in a predetermined repair decision analysis tree.

3. The computer system of claim 1, wherein each repair in the fourth group of repairs is a set of predefined steps.

4. The computer system of claim 1,
wherein the selected repair is a set of predefined steps; and
wherein at least one predefined step is optional.

5. A method for preparing a repair procedure, comprising:
selecting a discrepant item;
associating a unique identification datum with the discrepant item;
presenting a set of repair tasks associated with the discrepant item;
receiving a selected subset of the set of repair tasks;
associating the selected subset of repair tasks with the unique identification datum;
identifying a plurality of step/boiler names required to perform the selected subset of repair tasks; and
providing the plurality of step/boiler names to an authoring application.

6. The method of claim 5, further comprising:
receiving a set of access tasks associated with installation or removal of hardware that provides access to the discrepant item; and
associating the set of access tasks with the unique identification datum.

7. The method of claim 5, further comprising:
communicating with an outside database; and
receiving from the outside database the plurality of step/boiler names.

8. The method of claim 5, wherein the selecting step comprises navigating through a step process to identify a discrepant condition.

9. The method of claim 5, wherein the set of repair tasks includes all possible repair tasks associated with the discrepant item.

10. The method of claim 5, further comprising:
retrieving a plurality of step/boiler data from an authoring database in response to the plurality of step/boiler names; and
inserting the plurality of step/boiler data into a document.

11. The method of claim 5, wherein the unique identification datum is a unique identification number.

12. A computer system for producing a repair procedure, the computer system being configured for:
presenting a first group of components for selection;
receiving a first selected component from the first group of components;
presenting a second group of subcomponents for selection, the second group of subcomponents being determined in part by the first selected component;
receiving a second selected subcomponent from the second group of subcomponents;
presenting a third group of discrepancies for selection, the third group of discrepancies being determined in part by the second selected subcomponent;
receiving a third selected discrepancy from the third group of discrepancies;
presenting a fourth group of repairs for selection, the fourth group of repairs being determined in part by the third selected discrepancy; and
receiving a fourth selected repair from the fourth group of repairs;
wherein the first group of components, the second group of subcomponents, the third group of discrepancies and the fourth group of repairs are included in a predetermined repair decision analysis tree.

13. The computer system of claim 12, further comprising:
presenting a fifth group of components for selection, in response to the first selected component; and
receiving a fifth selected component from the fifth group of components.

14. The computer system of claim 12, further comprising:
presenting a sixth group of subcomponents for selection, in response to the second selected subcomponent; and
receiving a sixth selected subcomponent from the sixth group of subcomponents.

15. The computer system of claim 12, further comprising:
presenting a seventh group of discrepancies for selection, in response to the third selected discrepancy; and
receiving a seventh selected discrepancy from the seventh group of discrepancies.

16. The computer system of claim 12, further comprising:
presenting an eighth group of repairs for selection, in response to the fourth selected repair; and
receiving an eighth selected repair from the eighth group of repairs.

17. A computer system for producing a repair procedure, the computer system being configured for:
presenting a first group of elements in a first category for selection;
receiving a first selected element from the first group of elements;
presenting a second group of elements in a second category for selection in response to the first selected element;
receiving a second selected element from the second group of elements; and
providing a repair procedure determined in part by the second selected element;
wherein the first and second groups of elements are included in a predetermined repair decision analysis tree.

18. The computer system of claim 17, wherein the first and second categories are different.

19. The computer system of claim 17, wherein the first and second categories are the same.

20. The computer system of claim 17, wherein the provided repair procedure is determined in whole by the second selected element.

21. The computer system of claim 17, further comprising:
presenting a third group of elements in a third category for selection in response to the second selected element;
receiving a third selected element from the third group of elements;
presenting a fourth group of elements in a fourth category for selection in response to the third selected element;
receiving a fourth selected element from the fourth group of elements; and
producing a repair document in response to the fourth selected element;
wherein the first category is “component”;
wherein the second category is “subcomponent”;
wherein the third category is “discrepancy”;
wherein the fourth category is “repair”.
